(19) United States
(12) Patent Application Publication
(10) Pub. No.: US 2009/0321346 A1
(43) Pub. Date: Dec. 31, 2009

(54) Oil-Skimmer with two (2) or More Endless Flexibles Chains or O-rings as Conveying Elements and a fast and easy mountable magnetic base

(76) Inventors: Juergen Heberlein, Palm Harbor, FL (US); Alfred Uhl, Pfrdivten (DE)

Correspondence Address: Juergen Heberlein, 1320 El Pardo Drive, Trinity, FL, 34655, US

(21) Appl. No.: 12/493,127

(22) Filed: Jun. 26, 2009

Related U.S. Application Data
(60) Provisional application No. 61/075,802, filed on Jun. 26, 2008.

(51) Int. Cl. B01D 33/00

(52) U.S. Cl. 210/400

(57) ABSTRACT

An oil skimming device for removing tramp oil and floating particles from the surface of water-miscible liquids. The conveying elements of the skimmer are in the form of endless flexible chains or O-rings are being moved through the liquid by a drive element which is located above the liquid surface. The skimmer is easy to operate and can be” simple and fast mounted with a magnetic base to mostly any metal surfaces (cooling tank covers, machine body, etc. An oil skimmer device with a low degree of structural outlaws to provide a solution, for small upwardly open access areas in the tank or container and with changing liquid levels.

This application emanates from a previous filed provisional application; 61/075,802 file on Jun. 26, 2008

### FIELD OF THE INVENTION

The invention relates to an apparatus for removing tramp oil and floating particles from the surface of relatively heavy, usually water-miscible liquids. The apparatus is fast and easy mountable with the magnetic base to mostly any metal surfaces.

### BACKGROUND OF THE INVENTION

During cutting machining, cooling/lubricating liquids are directed over the cutting point, the intention being for said liquids to be subsequently collected and as far as possible re-used. However said cooling/lubricant liquids are mixed in an undesired manner with oil which stems for example from hydraulic-circuit leakages. Since these cooling/lubricating liquids are intended to be re-used and best of all even circulated, said oil must to the greatest extent be removed since it changes the properties of the cooling/lubricating substance in an undesired manner.

Whereas larger industrial enterprises, for this purpose install a central collection apparatus and cleaning of said cooling/lubricating or cleaning liquids, a considerable degree of structural and mechanical outlay being necessary for this. Midsize and smaller companies in contrast require an efficient, simple and cost-effective oil-skimmer which, in the collecting container or tank on the machine removes the tramp oil from the surface of the cooling/lubricating or cleaning liquid.

Most shops, especially those with numerous small coolant systems, want to make their coolants last indefinitely, and want to reduce waste and minimize the cost of fluid maintenance. To reach these goals, they must understand how coolant liquids become unstable, and they must be aware of the limits of filtering and recycling coolants.

However, tramp oil creates favorable condition for the growth of bacteria in the coolant and leaves an oil-residue on the machine and parts. The tramp oil creates an oil spray effect and reduces the coolant performance and oxygen intake of the coolant. The consequences may be expensive waste disposal, bacteria growth, unpleasant smell, increased maintenance, poor cooling performance and skin irritation.

The subject of the present invention is to provide, in particular, an oil skimmer which, with a low degree of structural outlaw and a small upwardly open access area in the container/tank, and along with changing filling level, removes floating oil from the liquid located there beneath. The oil-skimmer only requires a small opening of approximately 60 mm×60 mm to insert the chains or O-rings into the tank or container.

All the mechanical and electrical components of the oil skimmer with the exception of a wheel which may run in the lower loops (only with O-ring conveying elements) are located above the surface of the liquid.

The skimmer is easy to operate and can be easy and fast mounted with a magnetic base to mostly any metal surfaces (cooling tank covers, machine body, etc.). The lower guide element mounted in the running direction acts also as a stripper. The lower edge is designed that it falls away obliquely downwards from the chain, so that the stripped oil and floating particles moves along this lower edge and drips off at the end into the hose guide which serves to discharge the oil and particles which drips off the lower guide element and wiper.

### SUMMARY OF THE INVENTION

Apparatus for removing surface oil and floating particles from the surface of water-miscible liquids.

The conveying elements in the form of an endless flexible chain or O-ring are being moved through the liquid by a drive element which is located above the liquid surface.

The chain is produced from stainless steel material and the outer surface of the chain is of a cylindrical configuration (Snake Chain). The individual links have a certain degree of play with respect to one another in the longitudinal direction of the chain and when the chain is held down vertically are drawn apart to the maximum extent by the dead weight of the chain. This results in a distance of approximately 0.5 mm between the links. The oil adheres to a sufficiently great extent in these openings which run around the entire circumference of the chain, with the result that it reaches the wiper (stripper) without running off.

The characteristics for the drive elements are an aluminum pulley or antistactic plastic (used with the o-ring conveying elements) which has a diameter from 10 times to 20 times the diameter of the conveying element and is mounted onto a synchronous geared motor. The pulley has grooves which runs around the lateral surface and has a conical cross-section which tapers towards the base of the groove and in which the conveying elements runs. The walls of the groove enclose an angle of approximately 15° with respect to one another and are at such distance from one another that the chain or O-ring is not seated on the base of the groove. Sufficient friction for the drive of the chain or O-ring is obtained with the wedge-shaped groove design. The inclination of the two walls of the groove with respect to one another of 15° is sufficient to push the chains or O-rings so that the drive of the chain or O-ring is ensured, but on the other hand to avoid the chain or O-ring jamming in the groove.

The conveying elements are driven at approximately 10 to 15 revolutions per minute. The operating time in relation to the standstill time can be adjusted manually by means of a controller with a timer.

The wiper element (stripper) is made from rubber or plastic material and is located across the upper guide element in the running direction of the conveying element. The wiper element is mounted to the base of the housing via fastening elements. The rubber lip of the wiper presses against the upper guide element and the exposed lower side of the chain or O-ring. The groove of the upper guide element adapt to the external diameter of the chain or O-ring in order also to cause the oil to be stripped from the upper side of the chain or O-ring.

Upper and lower guide elements are made from antistatic plastic material. The lower guide element acts also as a stripper and is mounted to the housing via fastening elements. The lower edge of the lower guide element is extending away from the conveying element at an angle of at least 10° and terminates above the hose bracket which serves for discharge purpose. The lower edge surface of the lower guide element has machined V grooves to reduce the friction of the oil and particles too ensure fast dripping of oil and particles into the hose bracket. The upper and lower guides are of an accurate configuration, having a curvature which is not less than 10 times the diameter of the conveying element. The upper guide is located on the outer side of the conveying element and is level with the wiper (stripper). The upper and lower guides having cutouts which correspond to that part of the cross-section of the chain or O-ring and accurately guide the chain or O-ring to the wiper and disc (pulley) elements.

The synchronous geared motor, pulley, guide elements and wiper (stripper) are mounted on or in the base of a steel housing which by means of clamping elements can be adjusted and fixed along a horizontal bracket. The horizontal bracket is welded to a vertical square tube. An aluminum rod is located within the square tube and which by means of clamping elements can be adjusted vertically. A magnetic base is attached to the rod and is used to mount the oil-skimmer to mostly any metal surfaces.

A further increase in the conveying capacity occurs if a multitude of chains or O-rings are used and the chains or O-rings are guided parallel to one another at a small distance

Apparatus for removing oil layers and floating particles from the surface of water-miscible liquids. The oil-skimmer is fast and simple mounted with a magnet base to mostly any metal surfaces.

The oil-skimmer can be quickly adjusted vertically and horizontally and fixed with clamping elements to adjust the location of the conveying elements in reference to the water-miscible liquid surface.

The chain or O-ring being moved through the liquid by a drive element, which is located above the liquid and is in the form of a driving pulley, which has a surface texture suitable for transporting the endless conveying element.

The oil and floating particles adheres to great extent in the openings of the chain which run around the entire circumference of the chain, with the result that it reaches the wiper (stripper) without running off.

The conveying elements are driven at approximately 10 to 15 revolutions per minute.

The operating time in relation to the standstill time can be adjusted manually by means of a controller with a timer.

The wiper element (stripper) and guide elements are located in the running direction of the conveying element. During operation the chain or O-ring is guided thru the guide elements and passes thru the wiper element (striper). The wiper element presses against the upper guide element and removes the oil from the surface of the chain or O-ring. The lower guide element also acts as a stripper, the lower edge is designed that it falls away from the chain, so that the stripped oil and floating particles moves along this lower edge and drips off at the end into the hose guide which serves to discharge the oil and particles into a separate container.

### BRIEF DESCRIPTION OF THE DRAWING

FIG. 1; shows those parts which are arranged on or in the base of the housing

FIG. 2. shows the mounting and conveying parts of the oil-skimmer

FIG. 3. shows the swivel mounting base and tension rod and wheel

### DETAILED DESCRIPTION OF THE INVENTION

To be added

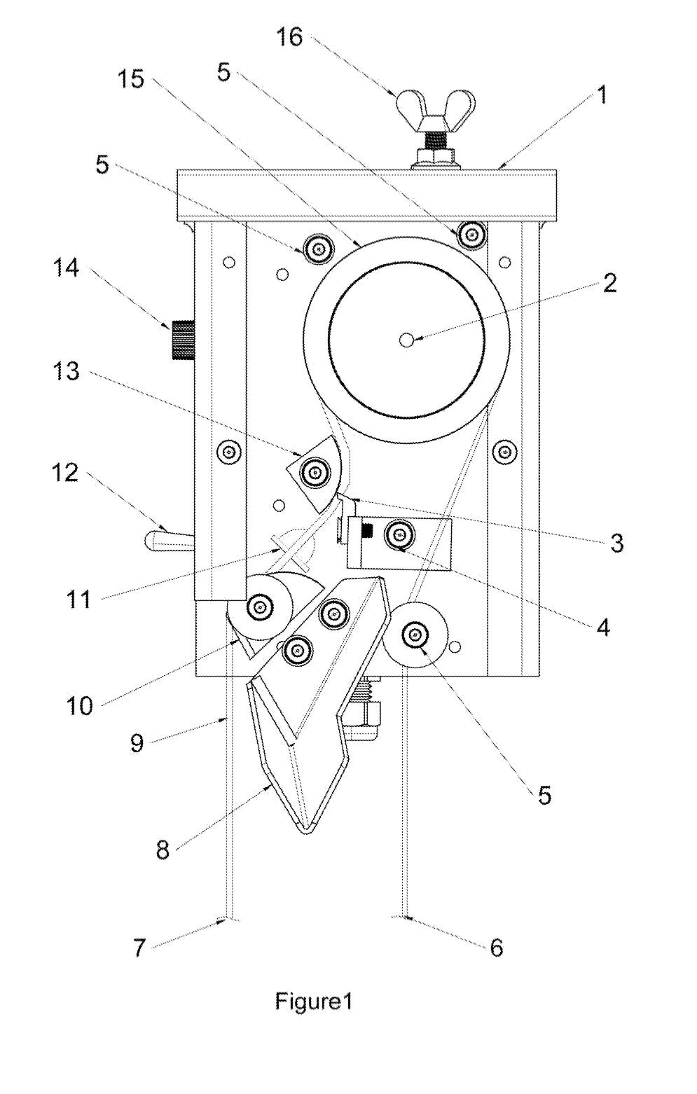

FIG. 1 shows all the components of the oil-skimmer which are arranged on or in the base of the skimmer housing; the synchronous geared motor (2) is mounted on the base of the housing (1) behind the pulley and cannot be seen; the pulley (15) is mounted onto the motor shaft being driven in rotation by the motor; and serving as drive element for the chain or O-ring (9) laid over it. Said chain or O-ring (9) is guided in the groove which is located in the outer surface of the pulley (2) and secured by two deflecting elements (5).

In the representation of FIG. 1, the pulley (15) and thus chains or O-rings (9), rotates in the clockwise direction when in operation, with the result that, in the representation, the rising strand (7) of the chain or O-ring is seen on the left-hand side and the falling strand (6) of the chain or O-ring is to be seen on the right-hand side.

Approximately 10 to 20 cm upstream of the pulley (15), in the running direction of the chain or O-ring (9), the lower guide element (10) is located within the chain or O-ring, said lower guide element (10) is pressing the chain or O-ring (9) further outwards than the position of the pulley (15). As the chain or O-ring (9) proceeds further, the upper guide element (13) is located likewise upstream of the pulley, in the running direction, but the upper guide element (13) is located outside the chain or O-ring and presses the chain or O-ring inwards from the abutment position of the lower guide element (10). Consequently, in the region between the upper and lower guide elements, the chain or O-ring (9) is moved out of the vertical into an obliquely rising, at most horizontal, position.

The upper and lower guide elements are fastened on the base of the housing (1) and on the outer surface along which the chain or O-ring (9), are of an accurate configuration, in which the grooves of the upper and lower guide elements serve for better guidance of the chain or O-ring (9). In this arrangement, the groove of the upper guide element (13) is adapted as well as possible to the outer contour of the chain or O-ring (9) and acts as a stripper for this part of the circumference of the chain or O-ring (9).

The stripper (3) presses against the upper guide element, said wiper comprising a rubber lip which is screwed firmly to a bracket (4) which, in turn, is screwed firmly onto the housing (1), said bracket (4) can be moved to adjust the wiper pressure. The rubber lip will form around the cross-section of the chain or O-ring (9) which projects out of the groove of the upper guide element (13).

The stripped tramp oil flows off along the rubber lip and drips off into the channel of the hose bracket (8) which is located beneath and via which the tramp oil will be disposed into a collecting container, which is not represented in FIG. 1 and can be set-up outside the oil-skimmer. In addition, the lower guide element edge (10) extends obliquely downwards away from the side located in the vicinity of the chain or O-ring (9), with the result that the oil which is received by the chain or O-ring (9) here runs off along this lower edge and, from the lower-lying end thereof remote from the chain or O-ring (9), likewise drips off into the channel of the hose bracket (8).

Also represented in FIG. 1 is a further solution of the stripper in the form of a brush element (11), as is used, for example, for guiding cables through walls, etc., said brush element (11), being arranged between the upper and lower guide elements and consisting conventionally of rubber or plastic. Said brush element (11) has a through-passage with a cross-section corresponding to the outer cross-section of the chain or O-ring (9), as a result of which the entire circumference of said chain or O-ring is stripped by the brush element (11).

In order to keep the distance small between the rising and the falling strands of the chain (9), so that a small opening in the container or tank for the liquid suffices for the lead-through of the chain (9), an additional deflection element (5), which is arranged outside the chain on the falling strand (6), deflects said chain in the direction of the rising strand (7) in order to reduce the distance between the strands.

Although, for functional reasons, the upper and lower guide elements requires a groove shape which corresponds to the circumferential shape of the chain or O-ring (9), but this is not the case for the deflection elements (5), all three deflection elements (5) may be of identical design.

FIG. 1 further depicts the controller/timer (14), with the aid of which the run cycle of the skimmer can be adjusted in relation to the break cycle thereof, since continuous operation of the skimmer is expedient only in the case of relative large quantities of tramp oil.

FIG. 1 further depicts the toggle switch (12), with the aid of which the skimmer can be turned on or off.

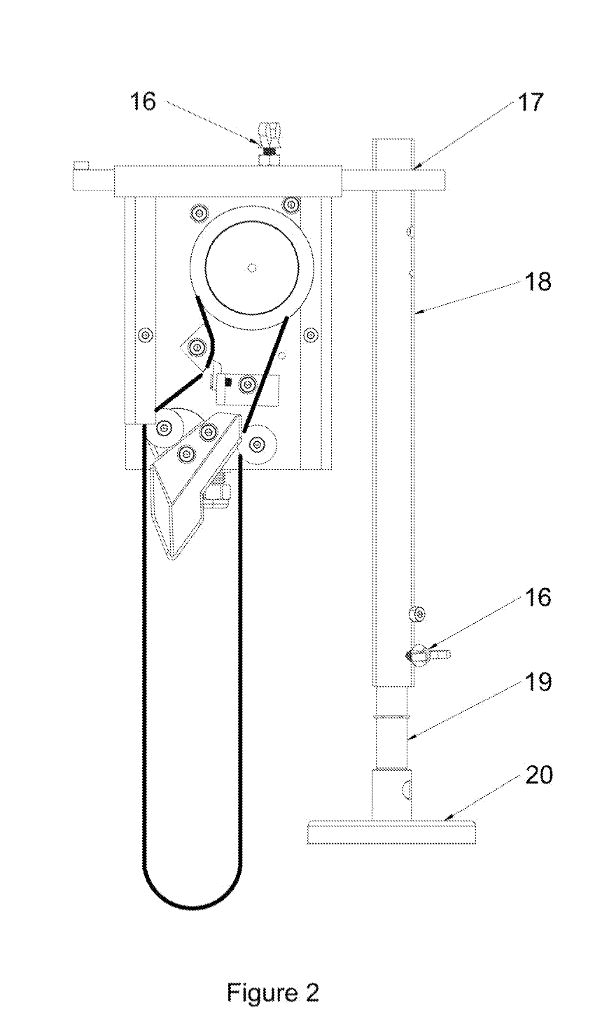

FIG. 2 shows the horizontal bracket (17) which is welded to the square tube (18), on which the housing (1) can be horizontally moved in position and fastened, with the aid of the clamping element (16).

FIG. 2 further shows the rod (19) on which the housing (1) can be adjusted in height, and fastened, with the aid of the clamping element (16). The magnetic base (20) is threaded onto the lower end of the rod (19), the magnetic base can be threaded vertically or horizontally to the rod (19) to provide various mounting solutions.

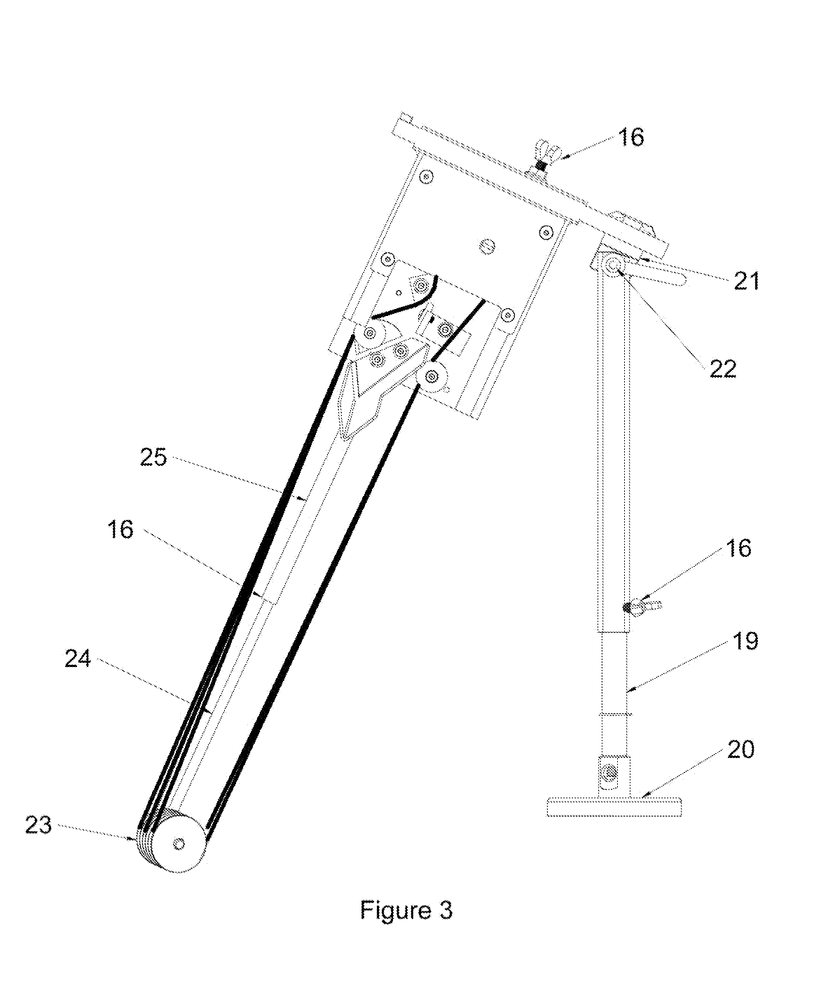

FIG. 3 shows a further solution of the mounting bracket in form of a swivel horizontal bracket (21), with the aid of the swivel bracket (21) the skimmer housing (1) can be swiveled horizontally and fastened with the aid of the adjustable lever handle (22).

FIG. 3 further shows parts of the oil skimmer which are arranged beneath the surface of liquid, namely the loop of the lower end of the circulating O-ring or chain (9). Located in said loop is the tension wheel (23) which, in turn, likewise has a groove which corresponds to the circumferential shape of the chain or O-ring (9), as a result of which the chain or O-ring (9) is guided securely at the lower end of the loop. For stabilization of the tension wheel there is attached axial a tension rod (24), to the tension wheel (23), which is guided vertically in the tension tube (25). The tension of the chain or O-ring (9) can be fast adjusted, with the movement of the tension rod (24) within the tension tube (25) and fastened with the aid of the clamping element (16). The tension tube is aligned and vertically spot welded to the hose bracket (8).

I claim:

1. Apparatus for separating tramp oil layers and floating particles in water miscible liquids, composed of at least one oil skimmer in the form off an flexible endless conveying element consisting of an oleophilic material, and of a stripper (3), the conveying element being moved through the liquid by a drive element which is locate above the liquid and is in the form of a driven wheel (15) which has a surface texture which is suitable for transporting the endless conveying elements (9), characterized that the conveying element is a stable chain (9) which consists of a endless flexible chain produced from stainless steel material and the outer surface of the chain is of a cylindrical configuration (Snake Chain) or rubber O-ring (9).

2. Apparatus according to claim 1, characterized in that the drive element is a pulley (15) and is composed of aluminum or plastic material and has grooves which runs around in the lateral surface of the pulley and has a conical cross-section which tapers towards the base of the groove and in which the conveying elements runs.

3. Apparatus according to claim 2, characterized in that the walls of the groove enclose an angle of 8° to 15°, preferable 15°, with respect to one another and are at such a distance from one another that the chain or O-ring (9) is not seated on the base of the groove, but the clear opening of the groove is greater than the diameter of the conveying elements.

4. Apparatus according to one of the preceding claims, characterized in that the stripper (3) is arranged upstream of the drive element, in the running direction of the conveying element, and the drive element has a diameter which is from 10 times to 20 times, preferably 15 times, the diameter of the conveying element.

5. Apparatus according to one of the preceding claims, characterized in that, in the event of a plurality of conveying elements (9) being arranged one beside the other, said conveying elements are guided such that the conveying element strands which rise up to the drive element (15) are spaced apart from one another by at least 1 mm.

6. Apparatus according to one of the preceding claims, characterized in that, in the region of the stripper (3), the conveying element is guided, by means of upper guide element (13), lower guide element (10), deflection elements (5), such that it rises obliquely in the running direction, the lower guide element (10) is located within the conveying element and upstream of the stripper (3), in the running direction, while the, upper guide element (13) is located on the outer side of the conveying element, level with the stripper (3),
The stripper (3) is a rubber lib and will form to the that part of the cross-section of the chain or O-ring (9) which projects out of the groove from the upper guide element (13), on their outer surface, in contact with the conveying element, the upper guide element (13) is of an accurate configuration, having a curvature which is not less than 10 times the diameter of the conveying element.

7. Apparatus according to claim 6, characterized in that the lower guide element (10) is mounted such that the lower edge, extending away from the conveying element, runs obliquely downwards at an angle of at least 10°, preferably 20°, and terminates above the hose bracket (8) which serves for discharge purpose.

8. Apparatus according to one of the preceding claims, characterized in that the endless flexible chain (9) consists, at least on its outer circumference, of stainless steel and is laser welded.

9. Apparatus according to one of the preceding claims, characterized in that the drive element is driven by means of a reversible synchronous geared motor, whose operating times in relation to the standstill times can be adjusted manually by means of a controller/timer (14), the intervals being in the region of a few minutes.

10. Apparatus according to one of the preceding claims, characterized in that, as the stripper, use is made of a rubber or plastic element (11) which fully encloses the chain or O-ring (9) and butts closely against the entire circumference thereof.

11. Apparatus according to one of the preceding claims, characterized in that at least the stripper (3), a discharge, the drive element, a pulley (15), the motor (2) and the controller/timer (14) are mounted on or in the base of the housing (1) which, by means of clamping elements (16) and adjustable lever handle (22), can be swiveled, adjusted horizontally, vertically and fixed, along a vertical rod (19) and or horizontal bracket (17) with the aid of the clamping elements (16), a magnetic base (20) being attached at the lower end of the rod (19), the magnetic base can be attached via thread, vertically or horizontally to the rod (19), to provide various mounting solutions.

12. Apparatus according to one of the preceding claims characterized in that, in the lower loop of the conveying element (9) between the rising strand (7) and the falling strand (6), a wheel (23) runs in said loop and is driven by the conveying elements (9).

13. Apparatus according to claim 12, characterized in that the wheel (23) can be vertically moved in position to adjust the tension of the conveying elements (9), and is fastened to the tension tube (25) with the aid of the clamping element (16).
